(19) United States
(12) Patent Application Publication
(10) Pub. No.: US 2018/0227619 A1
(43) Pub. Date: Aug. 9, 2018

(54) MULTIMEDIA SERVER, USER DEVICE, AND COMPUTER READABLE MEDIUM FOR BROADCASTING PROGRAMS ON-DEMAND WITH VIRTUAL CHANNELS

(71) Applicant: LI TV TAIWAN INC., Taipei City (TW)

(72) Inventors: Ta-Wei Chien, Taipei City (TW); Yu Chi Chang, Taipei City (TW); Hounien Lin, Taipei City (TW); Chin Hsiang Chang, Taipei City (TW); Chun-Hung Shih, Taipei City (TW)

(21) Appl. No.: 15/855,999

(22) Filed: Dec. 27, 2017

(30) Foreign Application Priority Data
Feb. 3, 2017 (TW) 106103643

(51) Int. Cl. H04N 21/262; H04N 21/266; H04N 21/472; H04N 21/482; H04N 21/4627; H04N 21/438

(52) U.S. Cl. CPC H04N 21/26258; H04N 21/26275; H04N 21/266; H04N 21/4383; H04N 21/47217; H04N 21/4825; H04N 21/4627; H04N 21/47202

(57) ABSTRACT

Disclosed is a multimedia server, including a virtual channel management unit, a virtual channel broadcasting unit, and a program on-demand playback unit. The virtual channel management unit associates a number of programs on-demand with a virtual channel, and creates a virtual schedule for the virtual channel. According to the virtual schedule, the virtual channel broadcasting unit provides broadcasting of the virtual channel to a number of nonspecific users. Meanwhile, the program on-demand playback unit, at any time in response to a user instruction selecting a program on-demand, provides the selected program to a user device.

This application is based on and claims the benefit of priority from Taiwan Patent Application 106103643, filed on Feb. 3, 2017.

### BACKGROUND OF THE INVENTION

### Field of the Invention

The present invention relates to multimedia program services and, more particularly, to a service whereby users select and watch/listen to multimedia programs.

### Description of the Prior Art

Video on demand services have become popular. For example, Internet Protocol television (IPTV) is offered by Netflix™ in the United States and some other countries. Video on demand services of this kind enable users to enjoy watching desirable programs on any device whenever and wherever they want.

Compared with conventional television channels, video on demand services free users from invariable, public-oriented program guides by allowing the users to decide freely a program to watch and when to watch it. In general, video on demand service providers often offer too many programs for the users to find a desirable program easily. In an attempt to find a desirable program quickly, the users may search for the desirable program by keywords, which, however is premised on the users' knowledge of the program—for example, having ever heard of its title or its actors' names.

To enable users to find desirable programs on-demand easily, US Pub. 20140359669 discloses a channel whereby users browse a program's preview and use the preview to determine whether to watch the program in its entirety, and discloses that a user enters into a system any useful program attributes whereby the system creates a personalized channel for the user. However, the channel disclosed in US Pub. 20140359669 is, at most, similar to a playlist for a number of previews, as disclosed in U.S. Pat. No. 6,668,377.

### SUMMARY OF THE INVENTION

From the perspective of user experience, conventional ways of watching television are characterized by mindless browsing (also known as channel surfing or channel changing)—watching TV not in anticipation of any specific TV program content, and finishing at will. When users change casually to a channel at odd moments, the program being played on the channel is seldom at its beginning but usually in progress. The users are likely to watch the program for a while. Afterward, the users either change to another channel when not impressed by the program or stay with the channel until the program ends when impressed. The aforesaid TV-watching behavior is also known as channel surfing or channel changing.

Another characteristic of mindless browsing is that the users are rarely reluctant to watch the program or baffled by the program just because they miss the commencement of the program, especially if the program is a non-movie one, such as TV series, talk show, and variety show, whose entirety is unimportant to the audience. Moreover, one of the reasons why mindless browsing is a generally accepted TV-watching behavior is that it puts the users' fingers at ease (because the users only need to manipulate a channel up/down key in order to change channel) while watching TV; furthermore, odds are mindless browsing will enable the users to come across a fascinating program sooner or later and then keep watching it joyfully without carrying out any additional operation. In short, people enjoy watching TV mainly because they are able to watch TV in a carefree, uninterrupted manner.

The aforesaid mindless-browsing TV watching behavior is not allowed in conventional video on demand services. What US Pub. 20140359669 discloses is browsing a program's preview with a channel up/down key rather than watching the program directly. According to US Pub. 20140359669, even if a program's preview fascinates users, the users will have to act in accordance with the conventional way of accessing video on demand services—the video on demand service system requests the users to confirm their selected program or even make a payment before playing the selected program from the beginning. Doing so, however, necessitates the users' carrying out additional operation, interrupts the users' TV watching session, and, more importantly, requires the users to watch the selected program from the beginning (i.e., brings the users the hassle of carrying out additional operation)—which contradict the aforesaid mindless-browsing TV watching behavior.

In view of the aforesaid drawbacks of the prior art, the present invention proposes coupling together multimedia programs on-demand to produce the concept of a virtual channel, which is similar to a conventional television channel. The virtual channel has a program schedule. Every program on the virtual channel is broadcast according to the program schedule of the virtual channel. Therefore, the content of the virtual channel, as watched by any given user, depends passively on the point in time when he switches to the virtual channel. Unless he leaves the virtual channel, he will be able to watch the remaining part of the program according to the program schedule, thereby allowing him to perform mindless-browsing TV watching behavior on a conventional television channel.

In addition, the present invention features integration of advantages of video on demand. For example, all the episodes (say, a total of 20 episodes) of a TV series are coupled together to create a virtual channel for the TV series. If the user switches to the virtual channel, is fascinated by the tenth episode currently being played halfway, and wants to watch the tenth episode from the beginning or goes quickly to any other part of the tenth episode, the user will not only be able to watch the tenth episode in a way similar to that of conventional video on demand by carrying out simple operation, but also be able to select and watch the other episodes of the TV series or the other related programs, according to the present invention.

Hence, the present invention enables users to enjoy the freedom and convenience provided by video on demand while performing mindless browsing on a conventional television channel.

As mentioned before, programs of the virtual channel are broadcast according to a program schedule of the virtual channel, whereas the program schedule does not need to be custom-made for any given user. Preferably, the program schedule is a public program schedule, i.e., like a program schedule of a conventional television channel. According to the present invention, broadcast is effectuated in a manner that substantially identical program content is watched by different users at the same time on the same virtual channel. That different users watching identical program content at the same time is attributed to one of the characteristics of conventional TV watching experience, which is conducive to real-time interaction and discussion (for example, at social networking sites and chat rooms) on currently-presented content between the users rather than restricted to individual experience. The aforesaid characteristic is presently absent from video on demand.

The present invention is advantageous, as far as the aforesaid characteristic is concerned. For instance, when users in a chat room are engaged in a heated discussion about the content of a program on a virtual channel, the system can present in real time the program to the users by video on demand and thus free the users from the restraint of a program guide, allowing the users to use video on demand to instantly play or go forward to the part which concerns the users.

Users are unlikely to discern any difference between the virtual channel of the present invention and a conventional television channel. Therefore, it is feasible to present the virtual channel and a conventional television channel concurrently to the users and allow the users to perform mindless browsing with a channel up/down key or by any other conventional means of channel changing (for example, entering a channel number), which conforms with the users' conventional behavior of browsing television channels. Conventional television channels (such as National Geographic Channel and BBC World News) and video on demand (VOD) are two separate service categories in MOD services provided by Taiwan's Chunghwa Telecom for example, and thus the users have to stop using the television channel services in order to access the video on demand services. By contrast, according to the present invention, the virtual channel and the conventional television channel are placed in the same service category to allow the users to perform mindless browsing simply by switching between the virtual channel and the conventional television channel; hence, the users need not learn new TV watching skills which might otherwise reduce the users' willingness to access the virtual channel.

As the virtual channel of the present invention is basically built on programs on-demand available in a conventional multimedia library as well as a program schedule, it incurs less cost than a conventional television channel. Therefore, it is easy to construct a hundred virtual channels, and users performing mindless browsing with the numerous channels are more likely to be psychologically satisfied.

In an embodiment, a multimedia server comprises:
a rebroadcast module for broadcasting to nonspecific users with a channel according to a program guide, wherein the channel has an external channel supply source and broadcasts not-on-demand multimedia programs; and
a program on-demand module, comprising:
   a program library unit for storing a plurality of multimedia programs on-demand;
   a virtual channel management unit for associating the multimedia programs on-demand with a virtual channel and creating a virtual program guide for the virtual channel;
   a virtual broadcast unit for broadcasting to nonspecific users with the virtual channel according to the virtual program guide; and
   a program on-demand playback unit, wherein, in response to a specific user's giving a selection command for one of the multimedia programs on-demand at any time, the program on-demand playback unit provides the multimedia program selected by the specific user to a user device and causes the user device to play the multimedia program selected by the specific user.

In another embodiment, a multimedia server comprises:
a program on-demand module, comprising:
   a program library unit for storing a plurality of multimedia programs on-demand;
   a virtual channel management unit for associating the multimedia programs on-demand with a virtual channel and creating a virtual program guide for the virtual channel;
   a virtual broadcast unit for broadcasting to nonspecific users with the virtual channel according to the virtual program guide; and
   a program on-demand playback unit, wherein, in response to a specific user's giving a selection command for one of the multimedia programs on-demand at any time, the program on-demand playback unit provides the multimedia program selected by the specific user to a user device and causes the user device to play the multimedia program selected by the specific user.

In yet another embodiment, a multimedia server comprises:
a program on-demand module, comprising:
   a program library unit for storing a plurality of multimedia programs on-demand;
   a message library unit for storing a plurality of not-on-demand multimedia messages;
   a virtual channel management unit for associating the multimedia programs on-demand and the not-on-demand multimedia messages with a virtual channel and creating a virtual program guide for the virtual channel;
   a virtual broadcast unit for broadcasting to nonspecific users with the virtual channel according to the virtual program guide; and
   a program on-demand playback unit, wherein, in response to a specific user's giving a selection command for one of the multimedia programs on-demand at any time, the program on-demand playback unit provides the multimedia program selected by the specific user to a user device and causes the user device to play the multimedia program selected by the specific user.

In another embodiment, the present invention provides a user device for operating in conjunction with the multimedia server, and a computer program product loaded to and executed by the user device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The following description, the appended claims, and the embodiments of the present invention further illustrate the features and advantages of the present invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a schematic view of the framework of an OTT multimedia system according to a specific embodiment of the present invention;

FIG. 2 is a block diagram of a multimedia server according to a specific embodiment of the present invention;

FIG. 3 is a schematic view of a list according to a specific embodiment of the present invention; and

FIG. 4 is a schematic view of the framework of a user device according to a specific embodiment of the present invention.

### DETAILED DESCRIPTION OF THE EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a computer system/device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

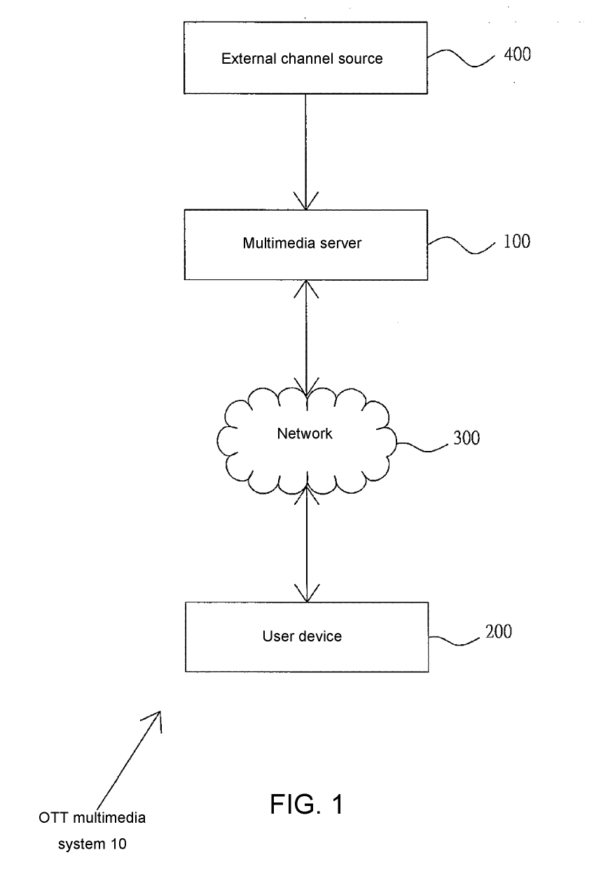

Referring now to FIG. 1 through FIG. 4, computer systems/devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

System Framework

FIG. 1 shows the framework of an over-the-top (OTT) multimedia system 10 according to an embodiment of the present invention. The OTT multimedia system 10 comprises a multimedia server 100 and a user device 200. The multimedia server 100 and the user device 200 are connected by a network 300. Preferably, the OTT multimedia server 100 is coupled to one or more external channel sources 400.

FIG. 1 is a schematic view which is simplified. In practice, the OTT multimedia system 10 comprises additional network devices, such as a gateway, a router, and a network access point (not shown). The multimedia server 100 and the user device 200 are provided in a plural number, but the present invention is not limited thereto.

For conventional features of the OTT multimedia system 10, please refer to conventional OTT multimedia systems, such as the MOD service system provided by Taiwan's Chunghwa Telecom, Internet television LiTV™, or video services offered by Netflix™. For further details, refer to US Pub. 20140359669, U.S. Pat. No. 6,668,377 and U.S. Pat. No. 9,225,762. The foresaid citation documents are cited hereunder as needed.

In an embodiment described below, the multimedia programs are exemplified by video programs, but persons skilled in the art are well aware that audio programs fall within the scope of the present invention too. For the prior art about a multimedia system dedicated to providing audio programs, refer to Spotify™, for example. Moreover, the term “users” used hereunder refers to persons accessing the OTT multimedia system 10; to this end, the users may or may not have to register or pay before acquiring access authority. In other words, the users could be unregistered users to the OTT multimedia system 10. The access authority thus acquired may vary from user to user. Therefore, the users do not necessarily watch the same content or use the identical services.

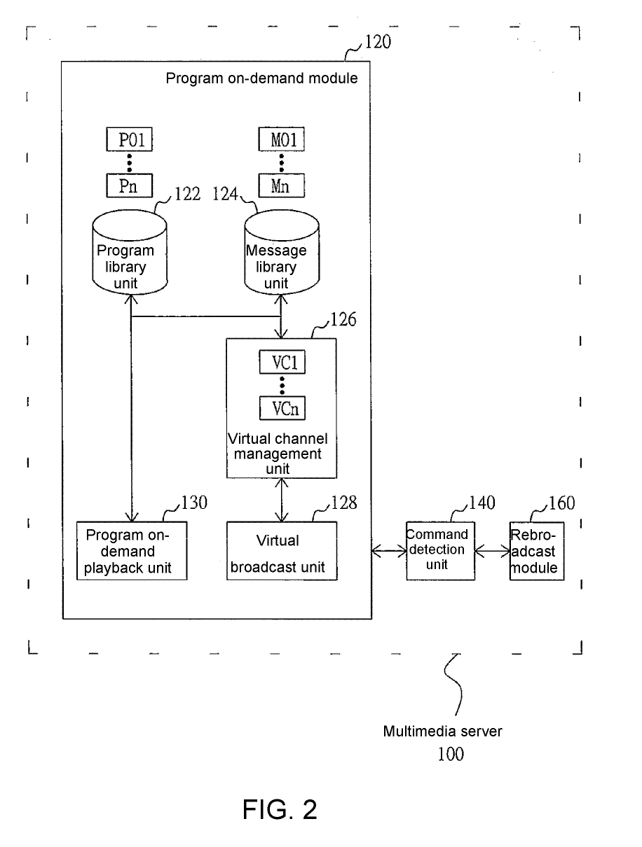

Referring to FIG. 2, the multimedia server 100 has a program on-demand module 120, a command detection unit 140, and a rebroadcast module 160. In this embodiment, the program on-demand module 120 further comprises a program library unit 122, a message library unit 124, a virtual channel management unit 126, a virtual broadcast unit 128, and a program on-demand playback unit 130. In this embodiment, the multimedia server 100 is a conventional multimedia content streaming server or even a virtual host. The aforesaid modules and units are implemented by software in a way similar to Amazon Cloudfront.

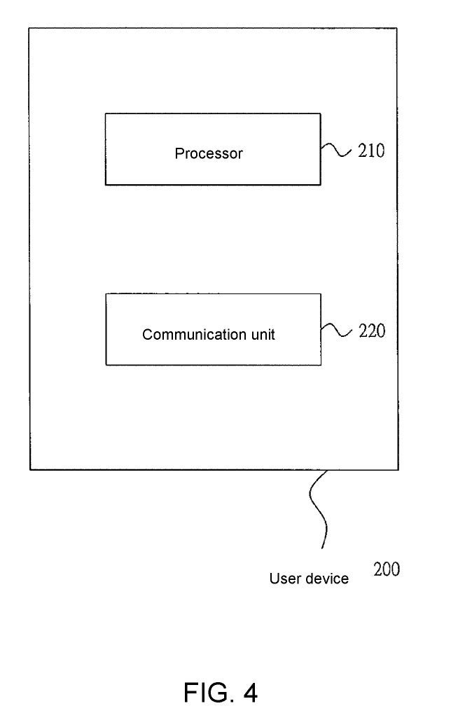

The program library unit 122 stores and manages a plurality of multimedia programs P1-Pn to be selected and watched by users. The multimedia programs P1-Pn can each be selected and watched by the users. The program on-demand playback unit 130 receives from a user a program selection command whereby the user selects a desirable program at any time, and then the program on-demand playback unit 130 transmits the selected program to the user device 200 specified by the user so that the user watches it on the user device 200. For further details, refer to conventional video on demand. The user device 200 is, for example, a cellular phone, tablet, desktop computer, Internet television set, or set-top box; for further details, see the description of FIG. 4 below.

The program library unit 122 stores multimedia programs on-demand, whereas the message library unit 124 stores not-on-demand multimedia messages M1-Mn, such as commercials. Hence, the users cannot watch the multimedia messages M1-Mn with the program on-demand playback unit 130. In a variant embodiment, the users cannot even search for, select or preview the multimedia messages M1-Mn. In other embodiment, the message library unit 124 is further connected to the Internet and uses a run-of-network (RON) model. In other words, the message library unit 124 does not have to store messages M1-Mn locally but remotely. A run-of-network advertising placement is similar to a run-of-site advertising placement, except that the advertisements appear on more than one site instead of an individual site.

In an embodiment, the multimedia programs P1-Pn stored in the program library unit 122 come in thousands and are increasing. To create a virtual channel (described in detail later), some programs are selected from the multimedia programs P1-Pn by the multimedia server 100 automatically or by a system administrator manually, whereas the virtual channel management unit 126 associates a selected program with one or more virtual channels, that is, treating the selected program as the content of the one or more virtual channels. Optionally, some messages are selected from the multimedia messages M1-Mn by the multimedia server 100 automatically or by a system administrator manually or according to a run-of-network scheme when the message library unit 124 uses a run-of-network (RON) model, whereas the selected messages and the selected programs are jointly associated with one or more virtual channels VC1-VCn. This is particularly useful to show advertisements M1-Mn to unregistered users. The arrangement of the virtual channels VC1-VCn or the arrangement of the programs in each virtual channel is either achieved manually or achieved by computer software automatically.

Optionally, like a cable television system, which gives a channel number to each television channel it provides so that its users can identify, recall or select the television channel by the channel number, the virtual channel management unit 126 gives a channel number to each virtual channel.

The virtual channel management unit 126 creates a virtual program guide for the virtual channel automatically or in accordance with commands given by a system administrator. The virtual program guide states the timing of broadcasting each selected program and/or message on the virtual channel.

For example, an embodiment involves selecting the multimedia programs P1-P100 to form virtual channel VC1, selecting the multimedia programs P51-P140 and the multimedia messages M1-M20 to form virtual channel VC2, and selecting the multimedia programs P101-P180 and the multimedia messages M10-M30 to form virtual channel VC3. A multimedia program or a multimedia message could be selected and allocated to at least two virtual channels. No restriction is placed on the quantity of the virtual channels and the quantity of the multimedia programs and multimedia messages for use by each virtual channel. However, the users dislike any virtual channel with a dearth of multimedia programs or a plethora of multimedia messages. Moreover, two different virtual channels may be built on identical multimedia programs or multimedia messages but applicable to different virtual program guides, thereby allowing for variations in the sequence or timing of broadcasting programs and messages on the two virtual channels.

Table 1 shows an example of a program guide of virtual channels VC1-VC3, wherein virtual channel VC1 has the multimedia programs instead of the multimedia messages (such as commercials), whereas virtual channels VC2, VC3 have the multimedia programs and the multimedia messages. The multimedia messages not only serve as commercials presented to the users, but also occupy odd moments left by the multimedia programs, because the duration of a program does not necessarily equal a multiple of an hour or a multiple of half an hour.

For example, on virtual channel VC2, program P88 played from 10 o'clock lasts just 57 minutes. Therefore, on virtual channel VC2, program P88 is followed by three minutes of message (commercial) M12, and program P120 is played from 11 o'clock exactly. In another example, on virtual channel VC3, five minutes of message (commercial) M18 is played from 11 o'clock, and then 55 minutes of program P199 is played so that program P199 ends at 12 o'clock exactly, allowing program P177 to be played from 12 o'clock exactly. Program P177 has an expected duration of 57 minutes but is interrupted immediately after it has been played for 28 minutes from its commencement. The interruption is required for insertion of three minutes of message (commercial) M12. Message (commercial) M12 is followed by the remaining 29 minutes' playing of program P177, allowing program P177 to end at 13:00. Hence, one of the features of the present invention is that each program on each virtual channel either starts hourly or ends hourly, which conforms with the users' conventional behavior of browsing television channels, because conventional television programs usually start hourly, but the present invention is not limited thereto. In another embodiment, in addition to either starting hourly or ending hourly, the programs on the virtual channels are timed by the aforesaid insertion of a message (commercial) so as to start at a specific point in time or end at a specific point in time. The specific point in time depends on users' typical TV watching behavior or a marketing strategy.

TABLE 1

| | 08:00 | 09:00 | 10:00 | | 11:00 | | 12:00 | | 13:00 |
|---|---|---|---|---|---|---|---|---|---|
| virtual | . . . | 09:00 | 10:00 | | 11:00 | | 12:00 | | . . . |
| channel | | program | program | | program | | program | | |
| VC1 | | P01 | P02 | | P53 | | P99 | | |
| virtual | | 09:00 | 10:00 | 10:57 | 11:00 | | 12:00 | | |
| channel | | program | program | message | program | | program | | |
| VC2 | | P51 | P88 | M12 | P123 | | P53 | | |
| virtual | | 09:00 | 10:00 | 10:20 | 11:00 | 11:05 | 12:00 | 12:28 | 12:31 |
| channel | | program | program | program | message | program | program | message | program |
| VC3 | | P105 | P122 | P119 | M18 | P120 | P177 | M12 | P177 |
| . . . | | | | | | | | | |

The virtual broadcast unit 128 broadcasts with virtual channels VC1-VC3 according to a virtual program guide shown in Table 1. When any user watches virtual channels VC1-VC3 successively with the user device 200, the content currently watched by the user depends on the virtual program guide shown in Table 1. The user can keep watching scheduled programs in accordance with the virtual program guide of Table 1 without selecting any program, unless the user changes to any other channel or carries out any other operation.

Compared with the broadcast of the virtual broadcast unit 128 with virtual channels VC1-VC3, the program on-demand playback unit 130, in response to a selection command given by a specific user and targeted at one of the multimedia programs P1-Pn at any time, provides the multimedia program selected by the specific user to the user device 200 specified by the specific user and causes the user device 200 to play the multimedia program selected by the specific user. Hence, the specific user watches the multimedia programs P1-Pn through the program on-demand playback unit 130, not only without being limited by the schedule shown in Table 1, but also without affecting the other users' use of the multimedia server 100.

In an embodiment, as shown in Table 1, if the user starts watching program P177 on virtual channel VC3 from 12:00 and wants to finish, the user will have to watch an inserted message (commercial) M12 at 12:28. If, however, the user chooses to watch program P177 with the program on-demand playback unit 130, the user can forward, reverse or pause as well as watch continuously program P177, without seeing any commercial. In another embodiment, if the user chooses to watch programs on-demand with the program on-demand playback unit 130, the program on-demand playback unit 130 can also insert a commercial between the programs or present a text commercial by scrolling text, though there is not any need to occupy odd moments left by the multimedia programs.

With the multimedia server 100 being equipped with the virtual broadcast unit 128 and the program on-demand playback unit 130 concurrently, the users can watch program P123 in two ways, namely, first, selecting and watching program P123 through the program on-demand playback unit 130 at any time, and, second, watching program P123 in accordance with the program guide of Table 1 on virtual channel VC2 from 11:00 but the user will be unable to watch program P123 if the user misses the time specified by the virtual program guide.

Moreover, preferably, the multimedia server 100 further has the rebroadcast module 160 for providing program content provided by the external channel source 400, preferably in real time but the present invention is not limited thereto, to the user device 200 which subscribes for the external channel (such as BBC World News channel). In this embodiment, the external channel source 400 is a television station, such as a provider of content of a conventional television channel, for example, BBC. In general, in addition to the OTT multimedia system 10, the external channel source 400 presents its channel content to users of different systems synchronously by the systems, such as satellites or cable television networks. Therefore, users of the OTT multimedia system 10 and users of cable television networks can watch the same channel content synchronously by the OTT multimedia system 10 and cable television networks. Therefore, the timing of broadcast of programs of the external channel, that is, a channel program guide, is usually set and managed by the external channel source 400. The multimedia server 100 in the OTT multimedia system 10 plays the same role as a rebroadcast station, does not get involved in arrangement of a program guide and content of the external channel but passively rebroadcasts to users of the OTT multimedia system 10 according to the program guide and content provided by the external channel source 400.

Like a cable television system, which gives a channel number to each television channel it provides so that its users can identify, recall or select the television channel by the channel number, the OTT multimedia system 10 gives a channel number to each external channel, as disclosed in the prior art related to Chunghwa Telecom's MOD service system or Internet television LiTV.

In an embodiment, a user gives various commands and transmits the commands to the multimedia server 100 by a button or a graphical user interface provided on the user device 200. The command detection unit 140 of the multimedia server 100 detects the user's commands, allowing a functional module or a functional unit to give a response.

In an embodiment, the user device 200 is a smartphone. Therefore, the user gives various operating commands with a graphical user interface displayed on a touchscreen. In another embodiment, the user device 200 is a television set equipped with a remote controller. Therefore, the user performs channel surfing with a remote controller (not shown) by, for example, pressing a channel up/down key or entering a channel number to give a channel surfing command. The user device 200 further has a user interface or a button (not shown) for generating a command of video on demand and sending it to the program on-demand playback unit 130, as disclosed in the prior art related to video on demand.

As described above, channel numbers are allocated to both the virtual channel and the external channel. For example, if the multimedia server 100 provides 90 virtual channels and 30 external channels, then the multimedia server 100 can allocate channel number 001-090 to the 90 virtual channels, respectively, and channel number 091-120 to the 30 external channels, respectively. Therefore, if a user presses a channel up key of the remote controller while watching the virtual channel allocated with channel number 089 and broadcast by the virtual broadcast unit 128, and the command detection unit 140 detects the channel surfing command, the command detection unit 140 will request the virtual broadcast unit 128 to broadcast the virtual channel with channel number 090 to the user, that is, changing to the virtual channel with channel number 090. Afterward, if the user presses the channel up key again, and the command detection unit 140 detects the channel surfing command, the command detection unit 140 will request the virtual broadcast unit 128 to stop but will request the rebroadcast module 160 to broadcast the external channel with channel number 091 to the user, that is, changing to the external channel with channel number 091. At this moment, if the user presses a channel down key, and the command detection unit 140 detects the channel surfing command, the command detection unit 140 will request the rebroadcast module 160 to stop but will request the virtual broadcast unit 128 to broadcast the virtual channel with channel number 090 to the user, that is, changing back to the virtual channel with channel number 090.

In addition to the channel up/down key, the user usually enters a channel number as the channel surfing command with number keys on the remote controller. After detecting the command, the command detection unit 140 requests the virtual broadcast unit 128 or the rebroadcast module 160 to provide a related virtual channel or external channel. In doing so, it is easy for the user to switch between numerous virtual channels and external channels and browse them, thereby allowing the user to watch TV in the same way as the user is used to changing and browsing the conventional television channel.

By performing channel surfing in the aforesaid manner, the virtual channel content or external channel content currently watched by the user depends on the program guide of the virtual channel (shown in Table 1) or external channel. In general, the user will be likely to begin watching from the middle of the program, unless the program has just started (for example, hourly). Moreover, the user can keep watching all the ensuing programs on the channel without taking any further action, provided that the user stays in the same channel (whether a virtual channel or an external channel).

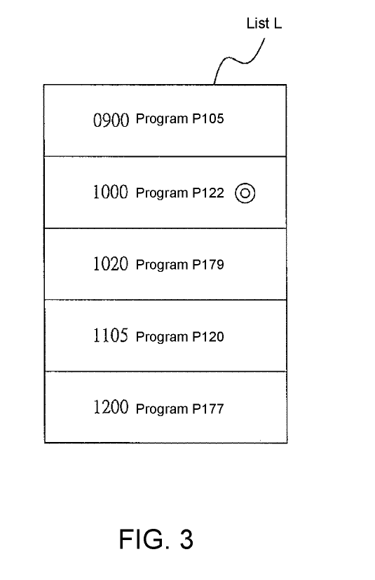

In an embodiment of the present invention, take the program guide of Table 1 as an example, if the user changes to virtual channel VC3 after 10:10, the virtual broadcast unit 128 will broadcast program P122 to the user according to the program guide, starting from the middle of program P122, thereby allowing the user not to watch program P122 from the beginning. However, after watching program P122 on virtual channel VC3 for a while, if the user is impressed by it and wants to know more about it, the user may send an enquiry command with an interface or a button on the user device 200. After detecting the enquiry command, the command detection unit 140 requests the virtual broadcast unit 128 to present a list L (shown in FIG. 3) to the user. The list L briefly shows a program guide for virtual channel VC3 and conspicuously shows program P122 currently being played. The user selects program P122 or any one of all the other programs on virtual channel VC3 by the list L, such as program P105, program P119, program P120, and program 177. In a preferred embodiment (not shown), the user further sends a command to adjust the way of displaying the list L, for example, additionally showing the data of each program or hiding the time of playing each program. If the time of playing each program is hidden, the user can adjust the sequence in which the programs are arranged in the list L so that the programs in the list are arranged, for example, according to popularity or time of launching, rather than according to the sequence specified in the program guide. In another embodiment (not shown), the user further enquires about any program in the list L, for example, as soon as the user selects program P122, to allow the list L to show every one of programs on-demand P1-Pn which is associated with program P122, for example, having the same theme or being performed by the same actor, wherein the programs which are associated with program P122 do not necessarily belong to virtual channel VC3.

The user gives a selection command to one of the programs shown in the list L with an interface or a button on the user device 200. After detecting the selection command, the command detection unit 140 requests the virtual broadcast unit 128 to stop and forwards the selection command to the program on-demand playback unit 130. In the same manner as it receives a program selection command from the user, the program on-demand playback unit 130 transmits a program selected by the user to the user device 200 specified by the user so as for the program to be played and watched by the user. Therefore, after watching program P122 on virtual channel VC3 for a while from 10:10, if the user is impressed by it and wants to know more about it, the user may select program P122 by the list L to therefore use the program on-demand playback unit 130 to watch program P122 from the beginning. Alternatively, the user makes an enquiry with the list L and selects program P02 associated with program P122 (for example, both program P02 and program P122 are about finance) so as to watch program P02 from beginning with the program on-demand playback unit 130, even though program P02 belongs to virtual channel VC1 rather than virtual channel VC3 currently watched by the user.

In another embodiment, the aforesaid way of changing from watching programs on a virtual channel by a list to watching programs by a program on-demand mode is configured to be only provided to a user who acquires specific access authority. Therefore, the virtual broadcast unit 128 determines whether the user has specific access authority. If the user does not have access authority, the list L will only be provided to the user for browsing the programs in the list, but the user cannot use the list L to select an intended program and watch the program by a program on-demand mode.

FIG. 4 is a schematic view of the framework of the user device 200 according to a specific embodiment of the present invention. As shown in the diagram, the user device 200 comprises a processor 210 and a communication unit 220. The user device 200 is, for example, a mobile phone, a tablet, or a smart television set, and has a display screen. However, the user device 200 can be, for example, a set-top box, and thus must be connected to a display unit in order to display a frame to the user.

The processor 210 is a universal processor loaded with a computer program and executed. The computer program is loaded to the user device 200 beforehand or is downloaded from a program market, such as Google Play, by the user later. After executing the program, the processor 210 cooperates and communicates with the multimedia server 100 shown in FIG. 2 through the communication unit 220. In particular, depending on the user's operation, after executing the program, the processor 210 sends the aforesaid operating commands to the multimedia server 100 through the communication unit 220 and processes (for example, decompresses and decodes) content attributed to the multimedia programs on-demand, virtual channel, or external channel and provided by the multimedia server 100, allowing the content to be played to the user. Related details are described above and thus are not described again herein. Optionally, the processor 210 is implemented by ASIC or FPGA, but the present invention is not limited thereto.

The present invention can be embodied in any other specific manners without departing from the spirit or essential features of the present invention. Every aspect of the aforesaid embodiments of the present invention must be deemed illustrative rather than restrictive of the present invention. Hence, the scope of the present invention is defined by the appended claims instead of the above description. All equivalent meanings and scope which fall within the appended claims must be deemed falling within the scope of the appended claims.

What is claimed is:

1. A multimedia server, comprising:
a rebroadcast module for broadcasting to nonspecific users with a channel according to a program guide, wherein the channel has an external channel supply source and broadcasts not-on-demand multimedia programs; and
a program on-demand module, comprising:
a program library unit for storing a plurality of multimedia programs on-demand;
a virtual channel management unit for associating the multimedia programs on-demand with a virtual channel and creating a virtual program guide for the virtual channel;
a virtual broadcast unit for broadcasting to nonspecific users with the virtual channel according to the virtual program guide; and
a program on-demand playback unit, wherein, in response to a specific user's giving a selection command for one of the multimedia programs on-demand at any time, the program on-demand playback unit provides the multimedia program selected by the specific user to a user device and causes the user device to play the multimedia program selected by the specific user.

2. The multimedia server of claim 1, further comprising a command detection unit for detecting for a channel surfing command of the specific user and, upon an affirmative detection, causing the virtual broadcast unit to provide content of the virtual channel to the user device and causing the user device to play current content of the virtual channel according to the virtual program guide.

3. The multimedia server of claim 2, wherein, when the command detection unit detects an additional channel surfing command of the specific user, the rebroadcast module provides content of the channel to the user device, and the user device plays current content of the channel according to the program guide.

4. The multimedia server of claim 2, wherein, during a time period in which the user device plays current content of the virtual channel according to the program guide, when the command detection unit detects an enquiry command of the specific user, the virtual broadcast unit provides a list of the multimedia programs on-demand to the user device, thereby allowing the specific user to browse the list and give the selection command for one of the multimedia programs in the list.

5. The multimedia server of claim 4, wherein an order in which the multimedia programs on-demand appear in the list is identical to an order in which the multimedia programs on-demand are played according to the virtual program guide.

6. The multimedia server of claim 5, wherein, when the user browses the list, the order in which the multimedia programs on-demand appear in the list is identical to the order in which the multimedia programs on-demand are played according to the virtual program guide.

7. The multimedia server of claim 2, wherein, during a time period in which the user device plays current content of the virtual channel according to the program guide, when the command detection unit detects an enquiry command of the specific user, the virtual broadcast unit provides a list of the multimedia programs on-demand to the user device after determining that the specific user has a given access authority, thereby allowing the specific user to browse the list and give the selection command for one of the multimedia programs in the list,
wherein, if the virtual broadcast unit determines that the specific user does not have the given access authority, the virtual broadcast unit presents the list but prohibits the specific user from giving the selection command for one of the multimedia programs in the list.

8. The multimedia server of claim 1, wherein the multimedia programs on-demand are each predetermined to belong to a first group and/or a second group so that the virtual channel management unit not only associates the multimedia programs of the first group with a first virtual channel and creates a first virtual program guide for the first virtual channel but also associates the multimedia programs of the second group with a second virtual channel and creates a second virtual program guide for the second virtual channel,
wherein the virtual broadcast unit broadcasts to nonspecific users with the first virtual channel and the second virtual channel according to the first virtual program guide and the second virtual program guide.

9. The multimedia server of claim 1, further comprising a command detection unit, wherein, when the command detection unit detects a channel surfing command of the specific user, the virtual broadcast unit provides content of the first virtual channel to the user device and causes the user device to play current content of the first virtual channel according to the first virtual program guide,
wherein, when the command detection unit detects an additional channel surfing command of the specific user, the virtual broadcast unit provides content of the second virtual channel to the user device, thereby allowing the user device to play current content of the second virtual channel according to the second virtual program guide.

10. The multimedia server of claim 1, wherein the program on-demand module further comprises a message library unit for storing a plurality of not-on-demand multimedia messages,
wherein the virtual channel management unit associates the not-on-demand multimedia messages with the virtual channel, and the virtual program guide further comprises data descriptive of points in time when the multimedia messages are played, thereby allowing the multimedia programs on-demand to alternate with the not-on-demand multimedia messages when broadcast with the virtual channel.

11. The multimedia server of claim 10, wherein, due to insertion of the not-on-demand multimedia messages, according to the virtual program guide, a said multimedia program on-demand is immediately followed by one of the not-on-demand multimedia messages and starts or ends hourly.

12. The multimedia server of claim 10, wherein, due to insertion of the not-on-demand multimedia messages, according to the virtual program guide, a said multimedia program on-demand is immediately followed by one of the not-on-demand multimedia messages and starts or ends at a specific point in time.

13. The multimedia server of claim 10, wherein the message library unit stores the plurality of not-on-demand multimedia messages locally.

14. The multimedia server of claim 10, wherein the message library unit is connected to Internet and uses a run-of-network model by storing the plurality of not-on-demand multimedia messages remotely.

15. The multimedia server of claim 1, wherein the specific user is an unregistered user to the multimedia server.

16. The multimedia server of claim 1, wherein the program on-demand module further comprises a message library unit for storing a plurality of not-on-demand multimedia messages,
wherein the virtual channel management unit associates the not-on-demand multimedia messages with the virtual channel, and the virtual program guide further comprises data descriptive of points in time when the multimedia messages are played, thereby allowing the multimedia programs on-demand to alternate with the not-on-demand multimedia messages when broadcast with the virtual channel when the specific user is an unregistered user to the multimedia server.

17. A user device for operating in conjunction with the multimedia server of claim 1, the user device comprising:
a processing unit; and
a communication unit for communicating with the multimedia server,
wherein the processing unit sends the selection command to the multimedia server through the communication unit, and the multimedia server provides the selected multimedia programs to the user device in response to the selection command, allowing the processing unit to process the selected multimedia programs and play the processed selected multimedia programs to a user,
wherein the processing unit sends a channel surfing command to the multimedia server through the communication unit, and the multimedia server provides content of the virtual channel to the user device in response to the channel surfing command, allowing the processing unit to process the current content of the virtual channel and play the processed current content of the virtual channel to the user.

18. A multimedia server, comprising:
a program on-demand module, comprising:
a program library unit for storing a plurality of multimedia programs on-demand;
a message library unit for storing a plurality of not-on-demand multimedia messages;
a virtual channel management unit for associating the multimedia programs on-demand and the not-on-demand multimedia messages with a virtual channel and creating a virtual program guide for the virtual channel;
a virtual broadcast unit for broadcasting to nonspecific users with the virtual channel according to the virtual program guide; and
a program on-demand playback unit, wherein, in response to a specific user's giving a selection command for one of the multimedia programs on-demand at any time, the program on-demand playback unit provides the multimedia program selected by the specific user to a user device and causes the user device to play the multimedia program selected by the specific user.
